(19) United States
(12) Patent Application Publication
(10) Pub. No.: US 2026/0352816 A1
(43) Pub. Date: Nov. 5, 2026

(54) ENCODING METHOD, DECODING METHOD, AND STORAGE MEDIUM

(71) Applicant: GUANGDONG OPPO MOBILE TELECOMMUNICATIONS CORP., LTD., Dongguan (CN)

(72) Inventors: Junyan HUO, Dongguan (CN); Yanzhuo MA, Dongguan (CN); Fuzheng YANG, Dongguan (CN); Zhenyao ZHANG, Dongguan (CN); Ming LI, Dongguan (CN)

(21) Appl. No.: 19/723,333

(22) Filed: Jun. 29, 2026

Related U.S. Application Data
(63) Continuation of application No. PCT/CN2024/070818, filed on Jan. 5, 2024.

(51) Int. Cl. H04N 19/11; H04N 19/105; H04N 19/176; H04N 19/70

(52) U.S. Cl. CPC H04N 19/11; H04N 19/105; H04N 19/176; H04N 19/70

(57) ABSTRACT

An encoding method, a decoding method, and a storage medium are provided. The decoding method includes the following. A bitstream is decoded to determine a prediction parameter of a current block, where the prediction parameter includes a first intra prediction mode. A first intra prediction value of a target sub-partition in the current block is determined according to the first intra prediction mode. A second intra prediction mode for the target sub-partition is determined based on a reference sample of the target sub-partition. A second intra prediction value of the target sub-partition is determined according to the second intra prediction mode. An intra prediction value of the target sub-partition is determined based on the first intra prediction value and the second intra prediction value. A reconstructed value of the target sub-partition is determined based on the intra prediction value of the target sub-partition.

### CROSS REFERENCE TO RELATED APPLICATION(S)

This application is a continuation of International Application No. PCT/CN2024/070818, filed Jan. 5, 2024, the entire disclosure of which is incorporated herein by reference.

### TECHNICAL FIELD

This disclosure relates to the field of video coding technology, in particular to an encoding method, a decoding method, and a storage medium.

### BACKGROUND

An intra sub-partitions (ISP) technology is used to split a coding block (CB) into several sub-partitions, such that a reconstructed sample of a previously coded sub-partition can serve as a reference for a next sub-partition, and all sub-partitions share the same intra prediction mode (IPM).

However, during an actual coding process, sub-partitions into which the same current block is partitioned may have different content characteristics, and the same intra prediction mode is used for all sub-partitions for prediction, which will reduce prediction accuracy, thereby affecting coding efficiency.

### SUMMARY

In a first aspect, a decoding method is provided in embodiments of the disclosure. The method is applied to a decoder and includes the following. A bitstream is decoded to determine a prediction parameter of a current block, where the prediction parameter includes a first intra prediction mode. A first intra prediction value of a target sub-partition in the current block is determined according to the first intra prediction mode. A second intra prediction mode for the target sub-partition is determined based on a reference sample of the target sub-partition, where the second intra prediction mode includes one or more intra prediction modes. A second intra prediction value of the target sub-partition is determined according to the second intra prediction mode, where the second intra prediction value includes one or more intra prediction values determined according to the one or more intra prediction modes included in the second intra prediction mode. An intra prediction value of the target sub-partition is determined based on the first intra prediction value and the second intra prediction value. A reconstructed value of the target sub-partition is determined based on the intra prediction value of the target sub-partition.

In a second aspect, an encoding method is provided in embodiments of the disclosure. The method is applied to an encoder and includes the following. A first intra prediction mode for a current block is determined. A first intra prediction value of a target sub-partition in the current block is determined according to the first intra prediction mode. A second intra prediction mode for the target sub-partition is determined based on a reference sample of the target sub-partition, where the second intra prediction mode includes one or more intra prediction modes. A second intra prediction value of the target sub-partition is determined according to the second intra prediction mode, where the second intra prediction value includes one or more intra prediction values determined according to the one or more intra prediction modes included in the second intra prediction mode. An intra prediction value of the target sub-partition is determined based on the first intra prediction value and the second intra prediction value. A reconstructed value of the target sub-partition is determined based on the intra prediction value of the target sub-partition.

In a third aspect, a non-transitory computer-readable storage medium is provided in embodiments of the disclosure. The computer-readable storage medium stores a bitstream and a computer program which, when executed by a processor, causes the processor to implement the method in the second aspect to generate the bitstream.

### BRIEF DESCRIPTION OF THE DRAWINGS

FIG. 1 is a schematic block diagram illustrating an encoder provided in embodiments of the disclosure.

FIG. 2 is a schematic block diagram illustrating a decoder provided in embodiments of the disclosure.

FIG. 3 is a schematic diagram illustrating a network architecture of a coding system provided in embodiments of the disclosure.

FIG. 4 is a schematic flowchart of a decoding method provided in embodiments of the disclosure.

FIG. 5 is a schematic diagram illustrating an intra sub-partitions (ISP) provided in embodiments of the disclosure.

FIG. 6 is a schematic diagram illustrating a position of a sub-partition relative to a current block in horizontal splitting provided in embodiments of the disclosure.

FIG. 7 is a schematic diagram illustrating a position of a sub-partition relative to a current block in vertical splitting provided in embodiments of the disclosure.

FIG. 8 is a schematic diagram of a histogram of gradients provided in embodiments of the disclosure.

FIG. 9 is a schematic diagram of a template region provided in embodiments of the disclosure.

FIG. 10 is a schematic flowchart of an encoding method provided in embodiments of the disclosure.

FIG. 11 is a schematic flowchart illustrating an encoding method and a decoding method provided in embodiments of the disclosure.

FIG. 12 is a schematic structural diagram of an encoder provided in embodiments of the disclosure.

FIG. 13 is a schematic diagram of a specific hardware structure of an encoder provided in embodiments of the disclosure.

FIG. 14 is a schematic structural diagram of a decoder provided in embodiments of the disclosure.

FIG. 15 is a schematic diagram of a specific hardware structure of a decoder provided in embodiments of the disclosure.

FIG. 16 is a schematic structural diagram of a coding system provided in embodiments of the disclosure.

### DETAILED DESCRIPTION

In order to provide a more detailed understanding of the features and technical contents of embodiments of the disclosure, implementations of embodiments of the disclosure will be described in detail below in conjunction with the accompanying drawings, which are provided for illustration only and are not intended to limit embodiments of the disclosure.

Unless otherwise defined, all technical and scientific terms used herein have the same meaning as commonly understood by those skilled in the art to which the disclosure relates. Terms used herein are for the purpose of describing embodiments of the disclosure only and are not intended to limit the disclosure.

In the following description, reference is made to “some embodiments” that describe a subset of all possible embodiments. However, it can be understood that “some embodiments” may be the same subset or different subsets of all possible embodiments and may be combined with each other without conflict. It is further to be pointed out that, the terms “first/second/third” involved in embodiments of the disclosure are merely used to distinguish similar objects, and do not represent a particular order for the objects. It can be understood that “first/second/third” may be interchanged in a particular order or sequence where allowed, such that embodiments of the disclosure described herein may be implemented in an order other than that illustrated or described herein.

Before further describing embodiments of the disclosure in detail, the terms and terminologies involved in embodiments of the disclosure will be described first, and the terms and terminologies related to embodiments of the disclosure are applicable to the following explanations:
coding block (CB);
block matching (BM);
coding unit (CU);
block vector (BV);
motion vector (MV);
sum of absolute difference (SAD);
sum of absolute transformed difference (SATD);
mean square error (MSE);
sum of squared differences (SSD);
mean absolute deviation (MAD);
mean square differences (MSD);
normalized correlation coefficient (NCC);
H.266/versatile video coding (VVC);
VVC test model (VTM);
template matching (TM);
intra template matching prediction (intra TMP);
intra block copy (IBC); and
enhanced compression model (ECM) beyond VVC.

It can be understood that in a video picture, a first colour component, a second colour component, and a third colour component are generally used to represent a current block. The three colour components are one luma component, one blue chroma component, and one red chroma component, respectively. Specifically, the luma component is usually represented by a symbol Y, the blue chroma component is usually represented by a symbol Cb or U, and the red chroma component is usually represented by a symbol Cr or V. In this way, the video picture may be represented in a YCbCr format or in a YUV format.

Various embodiments of the disclosure will be described in detail below with reference to the accompanying drawings.

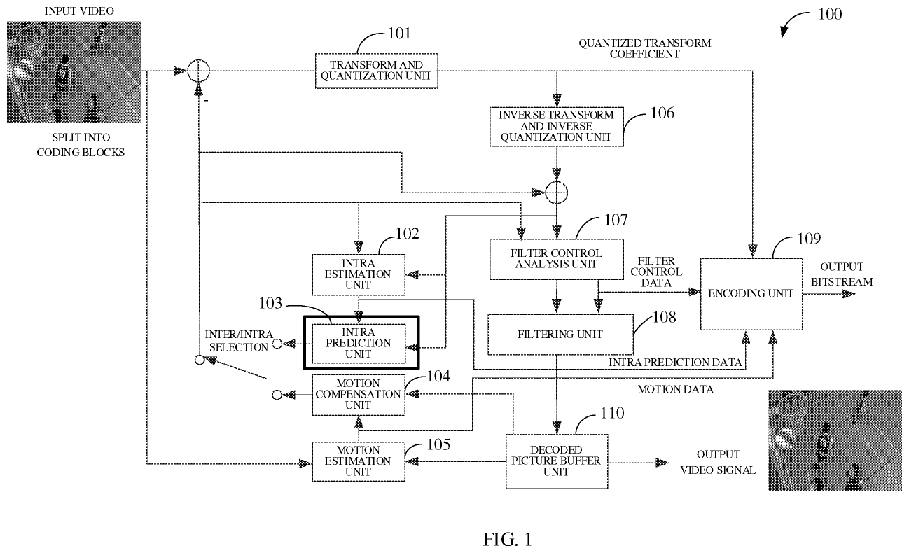

Reference may be made to FIG. 1, which illustrates a schematic block diagram of an encoder provided in embodiments of the disclosure. As illustrated in FIG. 1, an encoder (specifically, a “video encoder”) 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, an encoding unit 109, a decoded picture buffer unit 110, etc. The filtering unit 108 can implement de-block filtering and sample adaptive offset (SAO) filtering. The encoding unit 109 can implement header information encoding and context-based adaptive binary arithmetic coding (CABAC). For an input original video signal, a video encoding block can be obtained by partitioning a coding tree unit (CTU). Then, residual pixel information obtained after intra prediction or inter prediction is transformed by the transform and quantization unit 101 for the video encoding block, which includes that the residual information is transformed from a pixel domain to a transform domain, and an obtained transform coefficient is quantized to further reduce the bit rate. The intra estimation unit 102 and the intra prediction unit 103 are configured to perform intra prediction on the video encoding block. Specifically, the intra estimation unit 102 and the intra prediction unit 103 are configured to determine an intra prediction mode to be used for encoding the video encoding block. The motion compensation unit 104 and the motion estimation unit 105 are configured to perform inter prediction coding on the received video encoding block with respect to one or more blocks in one or more reference pictures, to provide temporal prediction information. Motion estimation performed by the motion estimation unit 105 is a process of generating an MV that may be used for estimating the motion of the video encoding block. Then, motion compensation is performed by the motion compensation unit 104 based on the MV determined by the motion estimation unit 105. After the intra prediction mode is determined by the intra prediction unit 103, the intra prediction unit 103 is further configured to supply selected intra prediction data to the encoding unit 109, and the motion estimation unit 105 is also configured to transmit MV data determined through calculation to the encoding unit 109. Further, the inverse transform and inverse quantization unit 106 is configured to reconstruct the video encoding block and reconstruct a residual block in the pixel domain. Block effect artifacts are removed from the reconstructed residual block by the filter control analysis unit 107 and the filtering unit 108. Then the reconstructed residual block is added to a predictive block in a picture in the decoded picture buffer unit 110, to generate a reconstructed video encoding block. The encoding unit 109 is configured to encode various encoding parameters and quantized transform coefficients. In a CABAC-based encoding algorithm, the context content may be based on neighbouring encoding blocks, and the encoding unit 109 may be configured to encode information indicating the determined intra prediction mode, to output a bitstream for the video signal. The decoded picture buffer unit 110 is configured to store the reconstructed video encoding block for prediction reference. As the video picture encoding proceeds, new reconstructed video encoding blocks are continuously generated, and all of these reconstructed video encoding blocks are stored in the decoded picture buffer unit 110.

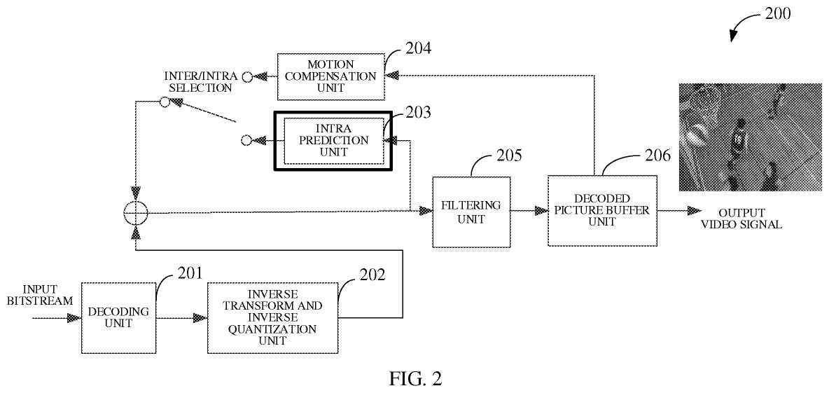

Reference may be made to FIG. 2, which illustrates a schematic block diagram of a decoder provided in embodiments of the disclosure. As illustrated in FIG. 2, a decoder (specifically, a “video decoder”) 200 includes a decoding unit 201, an inverse transform and inverse quantization unit 202, an intra prediction unit 203, a motion compensation unit 204, a filtering unit 205, a decoded picture buffer unit 206, etc. The decoding unit 201 can implement header information decoding and CABAC decoding. The filtering unit 205 can implement de-block filtering and SAO filtering. After an input video signal is processed through the encoding process of FIG. 1, a bitstream for the video signal is output. The bitstream is input into the decoder 200, first passes through the decoding unit 201 for obtaining a decoded transform coefficient. The transform coefficient is processed by the inverse transform and inverse quantization unit 202 to generate a residual block in a pixel domain. The intra prediction unit 203 can be configured to generate prediction data for a current video decoding block based on the determined intra prediction mode and data from previously decoding blocks in the current frame or picture. The motion compensation unit 204 determines prediction information for a video decoding block by parsing the MV and other associated syntax elements, and uses the prediction information to generate a predictive block of the video decoding block being decoded. A decoded video block is formed by summing the residual block from the inverse transform and inverse quantization unit 202 with the corresponding predictive block generated by the intra prediction unit 203 or the motion compensation unit 204. The decoded video signal passes through the filtering unit 205 so as to remove block artifacts, which may improve the video quality. The decoded video block is then stored in a decoded picture buffer unit 206, which stores reference pictures for subsequent intra prediction or motion compensation. The decoded picture buffer unit 206 is also configured to output the video signal. That is, the recovered original video signal is obtained.

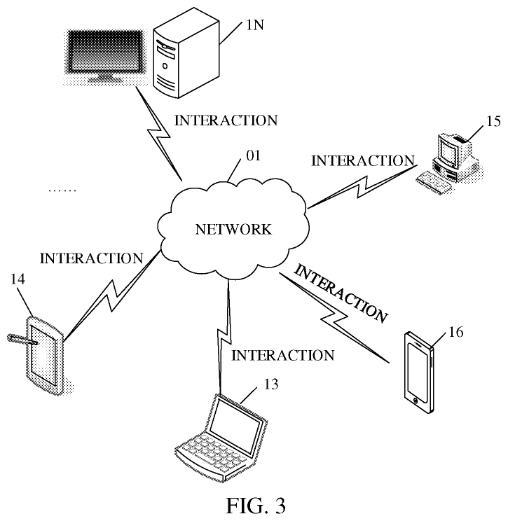

Further, a network architecture of a coding system including an encoder and a decoder is further provided in embodiments of the disclosure. FIG. 3 illustrates a schematic diagram of a network architecture of a coding system provided in embodiments of the disclosure. As illustrated in FIG. 3, the network architecture includes one or more electronic devices 13 to 1N and a communication network 01. The electronic devices 13 to 1N can perform video interaction through the communication network 01. In implementation, the electronic devices may be various types of devices having video encoding/decoding functions. For example, the electronic device may include a smartphone, a tablet, a personal computer, a personal digital assistant (PDA), a navigator, a digital phone, a video phone, a television, a sensing device, a server, etc., and is not specifically limited herein. In addition, the decoder or the encoder described in embodiments of the disclosure can be the electronic device mentioned above.

To significantly improve prediction accuracy, an intra sub-partitions (ISP) mode is used in VVC. The ISP mode is used to split a current block into several sub-partitions, such that a reconstructed sample of a previously coded sub-partition can serve as a reference for a next sub-partition, and all sub-partitions share the same intra prediction mode. However, during an actual coding process, sub-partitions into which the same current block is partitioned may have different content characteristics, and the same intra prediction mode is used for all sub-partitions for prediction, which will reduce the prediction accuracy, thereby affecting coding efficiency.

Based on this, an encoding method and a decoding method are provided in embodiments of the disclosure. In the disclosure, whether at an encoding end or a decoding end, when the ISP mode is used for the current block, content characteristics of a reconstructed region are fully utilized, a second intra prediction mode is adaptively selected, and fusion prediction is performed on sub-partitions by combining the second intra prediction mode with a first intra prediction mode, thereby improving prediction accuracy of the ISP mode, and thus further enhancing coding performance.

It can be noted that, the method in embodiments of the disclosure is mainly applied to the intra prediction unit 103 as illustrated in FIG. 1 and the intra prediction unit 203 as illustrated in FIG. 2. That is, embodiments of the disclosure may be applied to the encoder, may be applied to the decoder, and may even be applied to both the encoder and the decoder, which is not specifically limited in embodiments of the disclosure.

It can also be noted that, when embodiments of the disclosure are applied to the encoding end, the “current block” specifically refers to a current encoding block on which intra prediction is to be performed. When embodiments of the disclosure are applied to the decoding end, the “current block” specifically refers to a current decoding block on which intra prediction is to be performed.

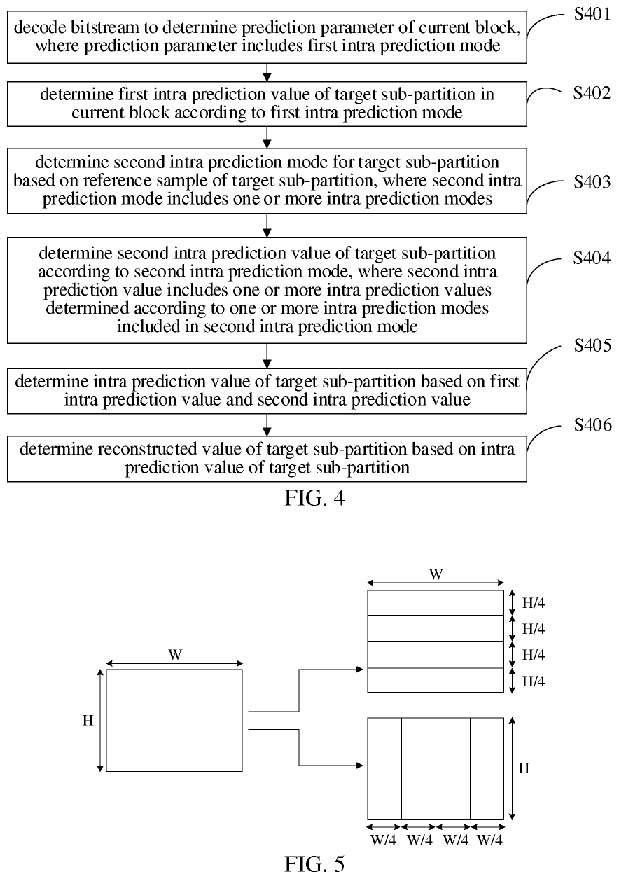

In an embodiment of the disclosure, reference may be made to FIG. 4, which illustrates a schematic flowchart of a decoding method provided in embodiments of the disclosure. As illustrated in FIG. 4, the method may include the following.

At S401, a bitstream is decoded to determine a prediction parameter of a current block, where the prediction parameter includes a first intra prediction mode.

The prediction parameter further includes any one or more parameters, other than the first intra prediction mode, for decoding the current block.

In some embodiments, the prediction parameter further includes a first syntax element, where the first syntax element indicates whether an ISP mode is used for the current block. Exemplarily, the bitstream is decoded to determine the prediction parameter of the current block as follows. The bitstream is decoded to determine the first syntax element of the current block. Based on the determination, according to the first syntax element, that the ISP mode is used for the current block, the bitstream is decoded to determine the first intra prediction mode. That is, based on the determination that the ISP mode or a derived mode of the ISP mode is used for the current block, the bitstream is decoded to determine the first intra prediction mode. The first intra prediction mode can be an optimal intra prediction mode for the current block. The optimal intra prediction mode may be determined and signalled into the bitstream by an encoding end for reading by the decoding end, or the optimal intra prediction mode may be derived by the decoding end according to a reconstructed neighbouring block of the current block. The derived mode of the ISP mode may be a new ISP-based prediction mode and different from the traditional ISP mode. The encoding end can perform encoding decision on different modes, select an optimal prediction mode, and transmit syntax element information through the bitstream for reading by the decoding end.

Further, based on the determination, according to the first syntax element, that the ISP mode is not used for the current block, the bitstream is decoded to determine another intra prediction mode, where the another intra prediction mode is a mode different from the ISP mode.

In some embodiments, the prediction parameter further includes a second syntax element, where the second syntax element indicates a split type for the current block. Exemplarily, the bitstream is further decoded to determine the prediction parameter of the current block as follows. Based on the determination, according to the first syntax element, that the ISP mode is used for the current block, the bitstream is decoded to determine the second syntax element. That is, based on the determination that the ISP mode or the derived mode of the ISP mode is used for the current block, the second syntax element also needs to be decoded to determine the split type for the current block. As such, the current block is split into several sub-partitions according to the split type, and prediction and reconstruction are performed on the sub-partitions sequentially from left to right or from top to bottom. Exemplarily, as illustrated in FIG. 5, the split type for the current block includes vertical splitting or horizontal splitting. With the ISP mode, intra prediction encoding can be performed based on sub-partitions in a CU, where a reconstructed sample of a previously coded sub-partition serves as a reference sample for a next sub-partition.

In some embodiments, the method further includes the following. The split type for the current block is determined according to the second syntax element. The number of sub-partitions into which the current block is split is determined according to the size of the current block. A decoding order of sub-partitions in the current block is determined according to the split type and the number of sub-partitions for the current block. The target sub-partition in the current block is determined according to the decoding order. That is, based on the determination that the ISP mode or the derived mode of the ISP mode is used for the current block, the number of sub-partitions also needs to be determined according to the size of the current block. Exemplarily, the number of sub-partitions is 2 or 4.

Exemplarily, a variable intra_subpartitions_mode_flag represents the first syntax element, indicating whether the ISP mode is used for the current block.

A variable intra_subpartitions_split_flag represents the second syntax element, indicating whether a split type for intra sub-partitions is horizontal or vertical.

A variable IntraSubPartitionsSplitType specifies a specific split type for a current luma CB, as illustrated in Table 1.

IntraSubPartitionsSplitType is derived as follows:
If intra_subpartitions_mode_flag is equal to 0, IntraSubPartitionsSplitType is set to 0.
Otherwise, IntraSubPartitionsSplitType is set to 1+intra_subpartitions_split_flag.

TABLE 1
Correspondence between values and names of IntraSubPartitionsSplitType

| | | Names of |
|---|---|---|
| Values of syntax element | IntraSubPartitionsSplitType | IntraSubPartitionsSplitType |
| intra_subpartitions_mode_flag is | 0 | ISP_NO_SPLIT |
| 0 | | |
| intra_subpartitions_mode_flag is | 1 | ISP_HOR_SPLIT |
| 1 and | | |
| intra_subpartitions_split_flag is 0 | | |
| intra_subpartitions_mode_flag is | 2 | ISP_VER_SPLIT |
| 1 and | | |
| intra_subpartitions_split_flag is 1 | | |

A variable NumIntraSubPartitions is used to specify the number of sub-partitions into which an intra luma CB is split. NumIntraSubPartitions is derived as follows:
If IntraSubPartitionsSplitType is equal to ISP_NO_SPLIT, NumIntraSubPartitions is set to 1.
Otherwise, if one of the following conditions is true, NumIntraSubPartitions is set to 2:
cbWidth is equal to 4, and cbHeight is equal to 8,
cbWidth is equal to 8, and cbHeight is equal to 4.
Otherwise, NumIntraSubPartitions is set equal to 4.

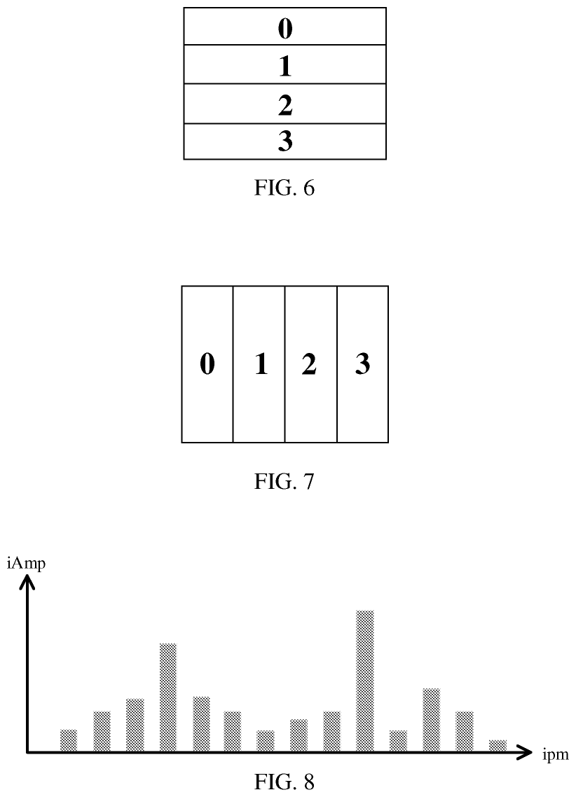

The current block can be split into NumIntraSubPartitions sub-partitions, and prediction and reconstruction on each sub-partition are completed according to a preset decoding order. As illustrated in FIG. 6, in horizontal splitting, the number of sub-partitions is 4, i.e., the variable intra_subpartitions_split_flag is 0, IntraSubPartitionsSplitType is 1, the variable NumIntraSubPartitions is 4, and sequence numbers from 0 to 3 of the sub-partitions represent the decoding order of the sub-partitions. As illustrated in FIG. 7, in vertical splitting, the number of sub-partitions is 4, i.e., the variable intra_subpartitions_split_flag is 1, IntraSubPartitionsSplitType is 2, the variable NumIntraSubPartitions is 4, and sequence numbers numbered from 0 to 3 of the sub-partitions represent the decoding order of the sub-partitions.

For a current sub-partition, a first intra prediction value of the current sub-partition is determined by performing prediction using the first intra prediction mode, a second intra prediction value of the current sub-partition is determined by performing prediction using a second intra prediction mode, and an intra prediction value of the current sub-partition is determined according to the first intra prediction value and the second intra prediction value.

At S402, a first intra prediction value of a target sub-partition in the current block is determined according to the first intra prediction mode.

It can be noted that, the first intra prediction mode can be any intra prediction mode. Exemplarily, the first intra prediction mode includes, but is not limited to: a PLANAR mode, a direct current (DC) mode, 65 angular prediction modes, and other intra prediction modes.

It can also be noted that, the target sub-partition can be one or more sub-partitions in the current block. Exemplarily, the target sub-partition may be any sub-partition in the current block, or may be certain specific sub-partitions in the current block.

At S403, a second intra prediction mode for the target sub-partition is determined based on a reference sample of the target sub-partition, where the second intra prediction mode includes one or more intra prediction modes.

The reference sample is a neighbouring reconstructed sample of the target sub-partition, specifically, a reconstructed sample of a reconstructed neighbouring block of the target sub-partition. In embodiments of the disclosure, the reference sample of the target sub-partition is fully utilized, such that the second intra prediction mode for the target sub-partition is determined, and weighted fusion prediction is performed on the target sub-partition by combining the second intra prediction mode with the first intra prediction mode, thereby improving prediction accuracy of the ISP mode.

In some embodiments, a reconstructed neighbouring block of the first sub-partition in the current block includes at least one of: a left neighbouring block of the first sub-partition, or a top neighbouring block of the first sub-partition, where the first sub-partition is a sub-partition to be decoded first according to a decoding order of sub-partitions in the current block. In some other embodiments, the reconstructed neighbouring block of the first sub-partition further includes at least one of: a bottom-left neighbouring block, a top-left neighbouring block, a top-right neighbouring block, another neighbouring block, or a non-neighbouring block of the first sub-partition.

In some embodiments, a reconstructed neighbouring block of another sub-partition in the current block includes one or more reconstructed sub-partitions in the current block. Part or all of reconstructed values of the one or more reconstructed sub-partitions are determined as reference samples for adaptively deriving the second intra prediction mode. The another sub-partition is one or more sub-partitions other than the first sub-partition determined according to the decoding order of sub-partitions in the current block. Exemplarily, taking a sub-partition numbered 2 in FIG. 6 and FIG. 7 as an example, the reconstructed neighbouring block includes, but is not limited to, a sub-partition numbered 0, a sub-partition numbered 1, or both the sub-partition numbered 0 and the sub-partition numbered 1.

In some other embodiments, the reconstructed neighbouring block of the another sub-partition further includes at least one of: another reconstructed neighbouring block or a non-neighbouring block of the another sub-partition.

In some embodiments, the prediction parameter further includes a third syntax element, where the third syntax element indicates whether the second intra prediction mode is used for the current block for fusion prediction. Correspondingly, the bitstream is further decoded to determine the prediction parameter of the current block as follows. Based on the determination, according to the first syntax element, that the ISP mode is used for the current block, the bitstream is decoded to determine the third syntax element.

Further, the method further includes the following. Based on the determination, according to a value of the third syntax element, that the second intra prediction mode is used for the current block for fusion prediction, the second intra prediction mode for the target sub-partition is determined based on the reference sample. Based on the determination, according to the value of the third syntax element, that the second intra prediction mode is not used for the current block for fusion prediction, the intra prediction value of the target sub-partition is determined based on the first intra prediction value.

Exemplarily, a variable intra_subpartitions_fusion_flag represents the third syntax element, indicating whether fusion prediction is performed on an intra sub-partition. When intra_subpartitions_fusion_flag is equal to 0, fusion prediction is not performed. When intra_subpartitions_fusion_flag is equal to 1, fusion prediction is performed, i.e., the second intra prediction mode is determined according to the reference sample of the current sub-partition.

In some embodiments, the second intra prediction mode for the target sub-partition is determined based on the reference sample as follows. Prediction performance parameters of multiple candidate intra prediction modes are determined by using a first derivation mode based on the reference sample. The one or more intra prediction modes included in the second intra prediction mode are determined according to the prediction performance parameters. The prediction performance parameter indicates the performance of the candidate intra prediction mode when the candidate intra prediction mode is used for performing prediction on the reference sample, and can serve as a basis for mode selection.

In some embodiments, the first derivation mode may be a derivation mode preset at the encoding end and the decoding end. In some other embodiments, the method further includes the following. The bitstream is decoded to determine the first derivation mode. That is, the encoding end determines an optimal derivation mode from multiple candidate derivation modes through encoding decision, and then signals the optimal derivation mode into the bitstream for reading by the decoding end.

Exemplarily, the first derivation mode includes a gradient-based derivation mode. A mode derivation method of the gradient-based derivation mode can include the following. Gradient analysis is performed on the reference sample to determine gradient magnitudes of multiple candidate intra prediction modes in a first mode set. When the gradient magnitudes of the multiple candidate intra prediction modes include a non-zero value, at least one gradient magnitude is determined according to a descending order of the gradient magnitudes. At least one mode index is determined according to a gradient angle corresponding to the at least one gradient magnitude. The one or more intra prediction modes included in the second intra prediction mode are determined according to the at least one mode index. The first mode set contains the multiple candidate intra prediction modes during gradient-based derivation. Exemplarily, the first mode set contains: a PLANAR mode, a DC mode, and 65 angular prediction modes. The first mode set may also contain other intra prediction modes.

The mode derivation method of the gradient-based derivation mode can further include the following. When the gradient magnitudes of the multiple candidate intra prediction modes do not include a non-zero value, determine that the second intra prediction mode includes a first preset mode. When the gradient magnitudes of the multiple candidate intra prediction modes include a non-zero value and the second intra prediction mode includes a second preset mode, a gradient magnitude of the second preset mode is updated to a first gradient magnitude, and other modes in the second intra prediction mode are searched according to the updated gradient magnitude.

That is, during gradient-based derivation, when all the gradient magnitudes of the candidate intra prediction modes are 0, the first preset mode can be selected as the second intra prediction mode, and the first preset mode may be the PLANAR mode or another default mode. When not all the gradient magnitudes of the candidate intra prediction modes are 0 and the second preset mode is found, the gradient magnitude of the second preset mode can be set to the first gradient magnitude (e.g., −1), such that the second intra prediction mode does not include the second preset mode. The second preset mode can be the first intra prediction mode. This ensures that the second intra prediction mode found based on the gradient-based derivation mode does not include the first intra prediction mode.

Exemplarily, a variable baseMode represents the first intra prediction mode, and a variable fusionMode represents the second intra prediction mode. When fusionMode includes two or more intra prediction modes, a variable NumFusionMode represents the number of elements in fusionMode.

Exemplarily, a sub-partition numbered 1 in horizontal splitting is taken as an example. Assume that coordinates of a top-left sample position of the current sub-partition relative to a top-left sample position of the picture are (x, y), the width of the sub-partition is Width, and the height of the sub-partition is Height.

Input: for the sub-partition, a luma sample in a reconstructed region in the current CB is p[x][y], where x=0 . . . Width−1, and y=−1 . . . −Height, i.e., a region of a sub-partition numbered 0. An origin point [0][0] is sample coordinates of a top-left corner in sub-partition 0. A sub-partition numbered 2 is taken as an example, and the input includes, but is not limited to, a reconstructed value of a sample in a sub-partition numbered 0, a reconstructed value of a sample in a sub-partition numbered 1, or both the reconstructed value of the sample in the sub-partition numbered 0 and the reconstructed value of the sample in the sub-partition numbered 1. The sub-partition numbered 0 is taken as an example, and the input includes, but is not limited to, a reconstructed value of a sample in a left neighbouring block and/or a reconstructed value of a sample in a top neighbouring block.

A gradient-based derivation process is as follows:
Set mapHgV={{2,1}, {1,2}} and mapVgH={{3,4}, {4,3}}
Set angTable={0, 2048, 4096, 6144, 8192, 12288, 16384, 20480, 24576, 28672, 32768, 36864, 40960, 47104, 53248, 59392, 65536}
Set angOffset={18, 18, 50, 50}
Set HoG[67] to be an array containing a gradient magnitude of each intra prediction mode. At the beginning of the process, all are initialized to zero.

For p[x][y], x=1 . . . Width−2, and y=−2 . . . −Height+1, i.e., only a gradient of a sample position inside the reconstructed region is calculated.

### Calculation:

A vertical gradient of each sample: gHor[x][y]=p[x−1][y−1]+2×p[x−1][y]+p[x−1][y+1]−p[x+1][y−1]−2×p[x+1][y]−p[x+1][y+1]
A horizontal gradient of each sample: gVer[x][y]=p[x−1][y−1]+2×p[x][y−1]+p[x+1][y−1]−p[x−1][y+1]−2×p[x][y+1]−p[x+1][y+1]
signH[x][y]=gHor[x][y]<0?1:0
signV[x][y]=gVer[x][y]<0?1:0
HgV[x][y]=(abs(gHor[x][y])>abs(gVer[x][y])?1:0) region[x][y]=(HgV[x][y]==1 ?mapHgV[signH[x][y]][signV[x][y]]: mapVgH[signH[x][y]][signV[x][y]])
grad[x][y]=(HgV[x][y]==1?abs(gVer[x][y])/abs(gHor[x][y]): abs(gVer[x][y])/abs(gHor[x][y]))
grad[x][y]=round(grad[x][y]*(1<<16))
Calculate an index of the closest intra prediction mode: angldx[x][y]=argmin i (abs(angTable[i]−grad[x][y]))
Calculate an intra prediction mode: ipm[x][y]=angOffset[region[x][y]]+angldx[x][y]
Gradient magnitude iAmp[x][y]=abs(gHor[x][y])+abs(gVer[x][y])

The gradient magnitude iAmp is accumulated for a corresponding intra prediction mode ipm, and a histogram of oriented gradients (HOG) is established, where the intra prediction mode ipm is taken as a horizontal axis, and the gradient magnitude iAmp is taken as a vertical axis, as illustrated in FIG. 8.

An array Weight represents a duplicate variable of HOG, used for calculating a weight.

If there is no non-zero value in the HOG, then all amplitudes in FIG. 8 are 0, and fusionMode is set to the PLANAR mode or another default mode.

Otherwise, fusionMode is set to argmax i (HoG[i]), and if fusionMode is equal to baseMode, then HoG[fusionMode] is set to −1.

If fusionMode is equal to baseMode, then searching is performed again, and fusionMode is set to argmax i (HoG[i]).

If NumFusionMode is greater than 1, then searching is performed repeatedly until an array fusionMode is filled.

Output: the second intra prediction mode fusionMode obtained through gradient-based derivation, with a mode index range of [0, 66].

Exemplarily, the first derivation mode includes a template-based derivation mode. A mode derivation method of the template-based derivation mode can include the following. Prediction is performed on the reference sample according to multiple candidate intra prediction modes in a second mode set, to determine prediction samples of the reference sample. Error values of the multiple candidate intra prediction modes in the second mode set are determined according to the reference sample and the prediction samples. The one or more intra prediction modes included in the second intra prediction mode are determined according to an ascending order of the error values. The second mode set contains the multiple candidate intra prediction modes during template-based derivation. Exemplarily, the second mode set may contain: a PLANAR mode, a DC mode, and 65 angular prediction modes. The second mode set may also contain other intra prediction modes.

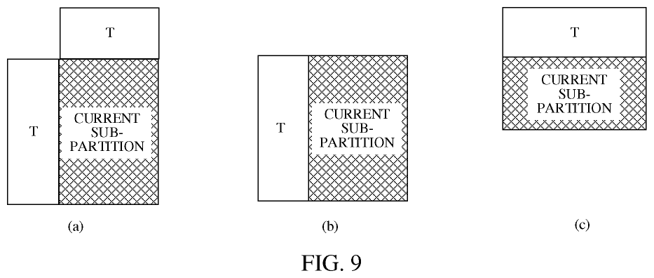

It can be noted that, during template matching (TM) technology-based mode derivation, the reference sample can be a reconstructed sample in a template region of a sub-partition. According to a reference sample of the template region, prediction is performed on a template region of a target sub-partition by using the multiple candidate intra prediction modes in the second mode set, to obtain prediction samples of the template region. Exemplarily, as illustrated in FIG. 9, when both a top reference sample and a left reference sample are available, a template shape is as illustrated in (a) of FIG. 9. When only the left reference sample is available, the template shape is as illustrated in (b) of FIG. 9. When only the top reference sample is available, the template shape is as illustrated in (c) of FIG. 9. The template region may also include at least one of: a top-left neighbouring block, a bottom-left neighbouring block, or a top-right neighbouring block.

The second mode set is traversed to perform prediction on the template region of the sub-partition, and certain error values between a prediction value and a reconstructed value are calculated, including but not limited to an SAD, an SATD, a sum of squared differences (SSE), an MAD, a mean absolute error (MAE), an MSE, a rate-distortion optimization (RDO) cost, etc. NumFusionMode intra prediction modes are selected according to the error values and then assigned to the array fusionMode.

A sub-partition numbered 1 in horizontal splitting is taken as an example.

The second mode set is traversed to perform prediction on a region of a sub-partition numbered 0, and certain error values between a prediction value and a reconstructed value are calculated, including but not limited to an SAD, an SATD, an SSE, an MAD, an MAE, an MSE, etc. NumFusionMode intra prediction modes are selected according to the error values and then assigned to the array fusionMode.

The sub-partition numbered 2 in horizontal splitting is taken as an example.

The second mode set is traversed to perform prediction on a region(s) of, including but not limited to, a sub-partition numbered 0, a sub-partition numbered 1, or both the sub-partition numbered 0 and the sub-partition numbered 1, and certain error values between a prediction value and a reconstructed value are calculated, including but not limited to an SAD, an SATD, an SSE, an MAD, an MAE, an MSE, etc. NumFusionMode intra prediction modes are selected according to the error values and then assigned to the array fusionMode.

Taking an SAD as an example, NumFusionMode intra prediction modes with the minimum SAD are selected as fusionMode.

In some embodiments, the second intra prediction mode further includes a third preset mode. That is, the second intra prediction mode may include certain fixed modes. Alternatively, when the first intra prediction mode and the derived second intra prediction mode satisfy certain conditions, determine that the second intra prediction mode includes the third preset mode. Exemplarily, the third preset mode can be the PLANAR mode.

At S404, a second intra prediction value of the target sub-partition is determined according to the second intra prediction mode, where the second intra prediction value includes one or more intra prediction values determined according to the one or more intra prediction modes included in the second intra prediction mode.

It can be understood that, when the second intra prediction mode includes one intra prediction mode, one second intra prediction value of the target sub-partition is determined according to the second intra prediction mode. When the second intra prediction mode includes multiple (two or more) intra prediction modes, multiple second intra prediction values of the target sub-partition are determined according to the second intra prediction mode.

At S405, an intra prediction value of the target sub-partition is determined based on the first intra prediction value and the second intra prediction value.

Exemplarily, weighted fusion is performed on the first intra prediction value and the second intra prediction value to determine the intra prediction value of the target sub-partition. The weighted fusion includes weighted fusion based on different weights and an averaging operation based on the same weight.

In some embodiments, the method further includes the following. A first weight of the first intra prediction value and a second weight of the second intra prediction value are determined based on a preset weight allocation strategy, where the second weight includes one or more weights corresponding to the one or more intra prediction values included in the second intra prediction value. That is, when the second intra prediction mode includes multiple (two or more) intra prediction modes, the second weight also includes multiple weights.

Exemplarily, the weight allocation strategy includes the following. When the second intra prediction mode includes a first preset mode, determine that the first weight is 1 and the second weight is 0. For example, the first preset mode may be the PLANAR mode or another default mode, and the another default mode may be an angular prediction mode.

Exemplarily, the weight allocation strategy includes the following. When the second intra prediction mode does not include the first preset mode, determine that the first weight is equal to the second weight. For example, each weight is a constant 1/n, where n is the number of modes used for weighted fusion.

Exemplarily, the weight allocation strategy can include determining a weight based on the prediction performance parameters of the intra prediction modes, where the prediction performance parameters indicate the performance of the first intra prediction mode and the second intra prediction mode when the first intra prediction mode and the second intra prediction mode are used for performing prediction on the reference sample, and can serve as a basis for weight allocation, to improve the prediction accuracy of the current block.

Specifically, the weight allocation strategy includes the following. A prediction performance parameter of the first intra prediction mode and a prediction performance parameter of the second intra prediction mode are added to obtain a total prediction performance parameter. The prediction performance parameter of the first intra prediction mode is divided by the total prediction performance parameter to obtain a first coefficient. The prediction performance parameter of the second intra prediction mode is divided by the total prediction performance parameter to obtain a second coefficient. Weight allocation is performed according to the first coefficient and the second coefficient to obtain the first weight and the second weight.

In some embodiments, weight allocation is performed according to the first coefficient and the second coefficient to obtain the first weight and the second weight as follows. A product of the first coefficient and a total weight is calculated to obtain the first weight. A product of the second coefficient and the total weight is calculated to obtain the second weight.

In some other embodiments, weight allocation is performed according to the first coefficient and the second coefficient to obtain the first weight and the second weight as follows. The total weight is split into a third weight and a fourth weight. A product of the first coefficient and the third weight is calculated and the fourth weight is added to the product, to obtain the first weight. A product of the second coefficient and the third weight is calculated to obtain the second weight.

Exemplarily, the variable baseMode represents the first intra prediction mode, and a variable baseMode Weight represents the first weight. The variable fusionMode represents the second intra prediction mode. An array fusionModeWeight contains the second weight of fusionMode. The variable NumFusionMode represents the number of elements in fusionMode and fusionModeWeight.

When the prediction performance parameter includes a gradient magnitude, a calculation process for the first weight baseMode Weight and the second weight fusionMode Weight includes, but is not limited to, the following:
Assume that a total sum of weights is sumOfWeight;
If fusionMode is the PLANAR mode or another default mode, then baseModeWeight is sumOfWeight, and fusionModeWeight is 0;
If HoG[baseMode] is 0, then baseModeWeight is sumOfWeight, and
fusionMode Weight is 0, or assuming that NumFusionMode is 1, then both baseModeWeight and fusionModeWeight are

$$\frac{sumOfWeight}{2} ;$$

and
If fusionMode is not the PLANAR mode or another default mode, assuming that NumFusionMode is 1, then both baseModeWeight and fusionModeWeight are

$$\frac{sumOfWeight}{2} ,$$

or baseModeWeight and fusionModeWeight are

$$\frac{s umOfWeight * H O G [ b aseMode ]}{H OG [ baseMode ] + H OG [ fusionMode ]} and$$

$$\frac{sumOfWeight * H O G [ f u sionMode ]}{H O G [ baseMode ] + H O G [ f u sionMode ]} ,$$

baseMode Weight and fusionModeWeight are

$$( \frac{sumOfWeight}{2} + \frac{sumOfWeight}{2} * \frac{HOG [ b aseMode ]}{HOG [ b aseMode ] + H O G [ fusionMode ]} )$$

$$and ( \frac{sumOfWeight}{2} * \frac{HOG [ f u s ionMode ]}{HOG [ b aseMode ] + HOG [ fusionMode ]} ) , etc .$$

Exemplarily, when the prediction performance parameter includes certain error values between a prediction value and a reconstructed value, taking an SAD as an example, the calculation process for the first weight baseMode Weight and the second weight fusionMode Weight includes, but is not limited to, the following:
Assume that a total sum of weights is sumOfWeight;
If fusionMode is the PLANAR mode or another default mode, then baseModeWeight is sumOfWeight, and fusionModeWeight is 0; and
If fusionMode is not the PLANAR mode or another default mode, assuming that NumFusionMode is 1, then both baseModeWeight and fusionModeWeight are

$$\frac{sumOfWeight}{2} ,$$

or baseModeWeight and fusionModeWeight are

$$\frac{sumOfWeight * SAD [ b aseMode ]}{SAD [ b aseMode ] + SAD [ fusionMode ]} and$$

$$\frac{sumOfWeight * SAD [ fusionMode ]}{SAD [ baseMode ] + SAD [ fusionMode ]} ,$$

or baseModeWeight and fusionModeWeight are fusionMode

$$( \frac{sumOfWeight}{2} * \frac{SAD [ b aseMode ]}{SAD [ baseMode ] + SAD [ fusionMode ]} ) and$$

$$( \frac{sumOfWeight}{2} + \frac{sumOfWeight}{2} * \frac{SAD [ fusionMode ]}{SAD [ b aseMode ] + SAD [ fusionMode ]} ) etc .$$

Further, intra weighted fusion prediction is performed on the current sub-partition. It can be noted that, during weighted prediction, prediction values of all modes may be weighted directly or sequentially. When the prediction values of all modes are weighted sequentially, a prediction value of each mode is incorporated and weighted by using a weight (1-p) and a weight p, where (1-p) is a weight of a previously weighted result, and p is a weight of a newly incorporated mode. p may be a constant or a value related to the prediction performance parameter. When p is the value related to the prediction performance parameter, (1-p) can be a cumulative sum of prediction performance parameters of modes previously weighted, and p is a prediction performance parameter of the newly incorporated mode.

In some embodiments, the method further includes the following. At least one of the first intra prediction mode, the second intra prediction mode, the first weight, or the second weight of the target sub-partition is stored. To fully utilize mode information of the current block for subsequent CBs, information, such as the second intra prediction mode, the weight, etc., can be stored in prediction information of each sub-partition, and the first intra prediction mode can be stored in prediction information of the current block as reference information for the subsequent CBs, to assist the prediction of the subsequent CBs.

At S406, a reconstructed value of the target sub-partition is determined based on the intra prediction value of the target sub-partition.

Exemplarily, the method further includes the following. The bitstream is decoded to determine a residual coefficient of the target sub-partition. Inverse quantization and inverse transform are performed on the residual coefficient, and then the reconstructed value of the sub-partition is obtained by combining the residual coefficient, subject to inverse quantization and inverse transform, with the intra prediction value of the sub-partition.

It can be noted that, if all sub-partitions in the current block have been reconstructed, the ISP mode for the current block will be exited, and a decoding process of a subsequent picture block will continue.

It can be noted that, the target sub-partition decoded using the decoding method provided in embodiments of the disclosure can be one or more sub-partitions in the current block. Exemplarily, the target sub-partition may be any sub-partition in the current block, or may be certain specific sub-partitions in the current block. Exemplarily, the specific sub-partitions can be sub-partitions other than the first sub-partition. When the sub-partition is the first sub-partition, an intra prediction value of the first sub-partition is determined based on the first intra prediction value. When the sub-partition is another sub-partition, both the first intra prediction mode and the second intra prediction mode are used for weighted prediction.

With the technical solutions mentioned above, at the decoding end, when the ISP mode is used for the current block, content characteristics of the reconstructed region are fully utilized, the second intra prediction mode is adaptively selected, and fusion prediction is performed on sub-partitions by combining the second intra prediction mode with the first intra prediction mode, thereby improving the prediction accuracy of the ISP mode, and thus further enhancing decoding performance.

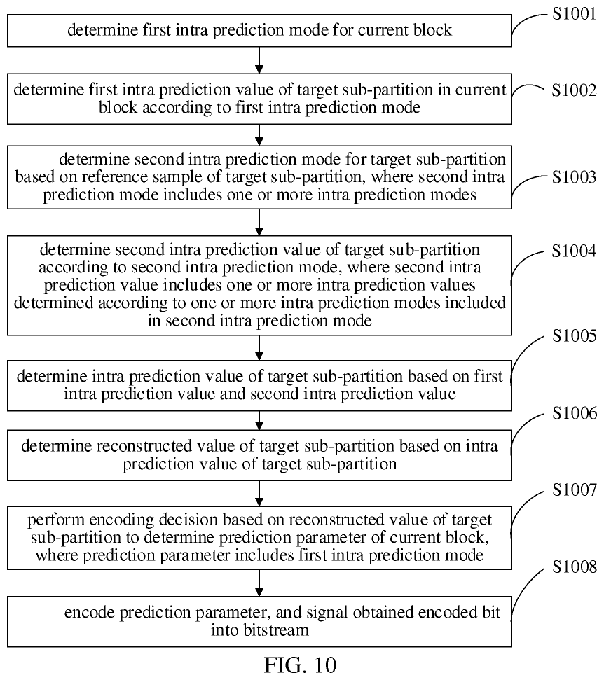

In yet another embodiment of the disclosure, reference may be made to FIG. 10, which illustrates a schematic flowchart of an encoding method provided in embodiments of the disclosure. As illustrated in FIG. 10, the encoding method may include the following.

At S1001, a first intra prediction mode for a current block is determined.

Exemplarily, based on the determination that an ISP mode is allowed to be used for the current block, the first intra prediction mode for the current block is determined. A syntax element indicating whether the ISP mode is allowed to be used for the current block may include at least one of: a CTU-level syntax element, a picture-level syntax element, a sequence-level syntax element, etc. Based on the determination, according to the syntax element, that the ISP mode or a derived mode of the ISP mode is allowed to be used for the current block, the first intra prediction mode is determined. The first intra prediction mode may be any candidate intra prediction mode. The encoding end selects, through encoding decision, an optimal intra prediction mode for the current block as a prediction parameter of the current block, and then signals the optimal intra prediction mode into a bitstream for reading by a decoding end. The first intra prediction mode may also be derived by the encoding end according to a reconstructed neighbouring block of the current block. The derived mode of the ISP mode may be a new ISP-based prediction mode and different from the traditional ISP mode. The encoding end can perform encoding decision on different modes, select an optimal prediction mode, and transmit syntax element information through the bitstream for reading by the decoding end.

In some embodiments, the method further includes the following. Multiple candidate split types for the current block are determined. The number of sub-partitions into which the current block is split is determined according to the size of the current block. Multiple candidate encoding orders of sub-partitions in the current block are determined according to the multiple candidate split types and the number of sub-partitions for the current block. The target sub-partition in the current block is determined according to the candidate encoding orders. That is, based on the determination that the ISP mode or the derived mode of the ISP mode is used for the current block, the current block also needs to be split into several sub-partitions according to the multiple candidate split types, and perform prediction and reconstruction on the sub-partitions sequentially from left to right or from top to bottom. Exemplarily, as illustrated in FIG. 5, the candidate split types include vertical splitting or horizontal splitting. With the ISP mode, intra prediction encoding can be performed based on sub-partitions in a CU, where a reconstructed sample of a previously coded sub-partition serves as a reference sample for a next sub-partition. Additionally, the number of sub-partitions also needs to be determined according to the size of the current block. Exemplarily, the number of sub-partitions is 2 or 4.

At S1002, a first intra prediction value of a target sub-partition in the current block is determined according to the first intra prediction mode.

It can be noted that, the first intra prediction mode can be any candidate intra prediction mode. Exemplarily, the first intra prediction mode includes, but is not limited to: a PLANAR mode, a DC mode, 65 angular prediction modes, and other intra prediction modes.

It can also be noted that, the target sub-partition can be one or more sub-partitions in the current block. Exemplarily, the target sub-partition may be any sub-partition in the current block, or may be certain specific sub-partitions in the current block.

At S1003, a second intra prediction mode for the target sub-partition is determined based on a reference sample of the target sub-partition, where the second intra prediction mode includes one or more intra prediction modes.

In some embodiments, based on the determination that the second intra prediction mode is allowed to be used for the current block for fusion prediction, the second intra prediction mode for the target sub-partition is determined based on the reference sample of the target sub-partition. Based on the determination that the second intra prediction mode is not allowed to be used for the current block for fusion prediction, the intra prediction value of the target sub-partition is determined based on the first intra prediction value.

A syntax element indicating whether the second intra prediction mode is allowed to be used for the current block for fusion prediction may include at least one of: a CTU-level syntax element, a picture-level syntax element, a sequence-level syntax element, etc. Whether the second intra prediction mode is allowed to be used for the current block for fusion prediction is determined according to the syntax element, where the current block is split by using the ISP mode or the derived mode of the ISP mode. If allowed, the encoding end performs prediction and reconstruction on the current block by using the prediction mode provided in embodiments of the disclosure, and compares a reconstructed value of the prediction mode with a reconstructed value of another prediction mode, to determine whether to use the prediction mode provided in embodiments of the disclosure. If not allowed, the traditional ISP mode can be used for prediction and reconstruction.

The reference sample is a neighbouring reconstructed sample of the target sub-partition, specifically, a reconstructed sample of a reconstructed neighbouring block of the target sub-partition. In embodiments of the disclosure, the reference sample of the target sub-partition is fully utilized, such that the second intra prediction mode for the target sub-partition is determined, and weighted fusion prediction is performed on the target sub-partition by combining the second intra prediction mode with the first intra prediction mode, thereby improving the prediction accuracy of the ISP mode.

In some embodiments, a reconstructed neighbouring block of the first sub-partition in the current block includes at least one of: a left neighbouring block of the first sub-partition, or a top neighbouring block of the first sub-partition, where the first sub-partition is a sub-partition to be encoded first according to an encoding order of sub-partitions in the current block. In some other embodiments, the reconstructed neighbouring block of the first sub-partition further includes at least one of: a bottom-left neighbouring block, a top-left neighbouring block, a top-right neighbouring block, another neighbouring block, or a non-neighbouring block of the first sub-partition.

In some embodiments, a reconstructed neighbouring block of another sub-partition in the current block includes one or more reconstructed sub-partitions in the current block. Part or all of reconstructed values of the one or more reconstructed sub-partitions are determined as reference samples for adaptively deriving the second intra prediction mode. The another sub-partition is one or more sub-partitions other than the first sub-partition determined according to the encoding order of sub-partitions in the current block. Exemplarily, taking a sub-partition numbered 2 in FIG. 6 and FIG. 7 as an example, the reconstructed neighbouring block includes, but is not limited to, a sub-partition numbered 0, a sub-partition numbered 1, or both the sub-partition numbered 0 and the sub-partition numbered 1.

In some other embodiments, the reconstructed neighbouring block of the another sub-partition further includes at least one of: another reconstructed neighbouring block or a non-neighbouring block of the another sub-partition.

In some embodiments, the second intra prediction mode for the target sub-partition is determined based on the reference sample as follows. Prediction performance parameters of multiple candidate intra prediction modes are determined by using a first derivation mode based on the reference sample. The one or more intra prediction modes included in the second intra prediction mode are determined according to the prediction performance parameters. The prediction performance parameter indicates the performance of the candidate intra prediction mode when the candidate intra prediction mode is used for performing prediction on the reference sample, and can serve as a basis for mode selection.

In some embodiments, the first derivation mode may be a derivation mode preset at the encoding end and the decoding end. In some other embodiments, the method further includes the following. The first derivation mode is encoded. That is, the encoding end determines an optimal derivation mode from multiple candidate derivation modes through encoding decision, and then signals the optimal derivation mode into the bitstream for reading by the decoding end.

Exemplarily, the first derivation mode includes a gradient-based derivation mode. A mode derivation method of the gradient-based derivation mode can include the following. Gradient analysis is performed on the reference sample to determine gradient magnitudes of multiple candidate intra prediction modes in a first mode set. When the gradient magnitudes of the multiple candidate intra prediction modes include a non-zero value, at least one gradient magnitude is determined according to a descending order of the gradient magnitudes. At least one mode index is determined according to a gradient angle corresponding to the at least one gradient magnitude. The one or more intra prediction modes included in the second intra prediction mode are determined according to the at least one mode index. The first mode set contains the multiple candidate intra prediction modes during gradient-based derivation. Exemplarily, the first mode set contains: a PLANAR mode, a DC mode, and 65 angular prediction modes. The first mode set may also contain other intra prediction modes.

The mode derivation method of the gradient-based derivation mode can further include the following. When the gradient magnitudes of the multiple candidate intra prediction modes do not include a non-zero value, determine that the second intra prediction mode includes a first preset mode. When the gradient magnitudes of the multiple candidate intra prediction modes include a non-zero value and the second intra prediction mode includes a second preset mode, a gradient magnitude of the second preset mode is updated to a first gradient magnitude, and other modes in the second intra prediction mode are searched according to the updated gradient magnitude.

That is, during gradient-based derivation, when all the gradient magnitudes of the candidate intra prediction modes are 0, the first preset mode can be selected as the second intra prediction mode, and the first preset mode may be the PLANAR mode or another default mode. When not all the gradient magnitudes of the candidate intra prediction modes are 0 and the second preset mode is found, the gradient magnitude of the second preset mode can be set to the first gradient magnitude (e.g., −1), such that the second intra prediction mode does not include the second preset mode. The second preset mode can be the first intra prediction mode. This ensures that the second intra prediction mode found based on the gradient-based derivation mode does not include the first intra prediction mode.

Exemplarily, the first derivation mode includes a template-based derivation mode. A mode derivation method of the template-based derivation mode can include the following. Prediction is performed on the reference sample according to multiple candidate intra prediction modes in a second mode set, to determine prediction samples of the reference sample. Error values of the multiple candidate intra prediction modes in the second mode set are determined according to the reference sample and the prediction samples. The one or more intra prediction modes included in the second intra prediction mode are determined according to an ascending order of the error values. The second mode set contains the multiple candidate intra prediction modes during template-based derivation. Exemplarily, the second mode set may contain: a PLANAR mode, a DC mode, and 65 angular prediction modes. The second mode set may also contain other intra prediction modes.

It can be noted that, during TM technology-based mode derivation, the reference sample can be a reconstructed sample in a template region of the sub-partition. According to a reference sample of the template region, prediction is performed on a template region of a target sub-partition by using the multiple candidate intra prediction modes in the second mode set, to obtain prediction samples of the template region. Exemplarily, as illustrated in FIG. 9, the template region may include one of the following. When a top reference sample, and a left reference sample are all available, a template shape is as illustrated in (a) of FIG. 9. When only the left reference sample is available, the template shape is as illustrated in (b) of FIG. 9. When only the top reference sample is available, the template shape is as illustrated in (c) of FIG. 9. The template region may also include at least one of: a top-left neighbouring block, a bottom-left neighbouring block, or a top-right neighbouring block.

The second mode set is traversed to perform prediction on the template region of the sub-partition, and certain error values between a prediction value and a reconstructed value are calculated, including but not limited to an SAD, an SATD, an SSE, an MAD, an MAE, an MSE, an RDO cost, etc. NumFusionMode intra prediction modes are selected according to the error values and then assigned to the array fusionMode.

In some embodiments, the second intra prediction mode further includes a third preset mode. That is, the second intra prediction mode may include certain fixed modes. Alternatively, when the first intra prediction mode and the derived second intra prediction mode satisfy certain conditions, determine that the second intra prediction mode includes the third preset mode. Exemplarily, the third preset mode can be the PLANAR mode.

At S1004, a second intra prediction value of the target sub-partition is determined according to the second intra prediction mode, where the second intra prediction value includes one or more intra prediction values determined according to the one or more intra prediction modes included in the second intra prediction mode.

It can be understood that, when the second intra prediction mode includes one intra prediction mode, one second intra prediction value of the target sub-partition is determined according to the second intra prediction mode. When the second intra prediction mode includes multiple (two or more) intra prediction modes, multiple second intra prediction values of the target sub-partition are determined according to the second intra prediction mode.

At S1005, an intra prediction value of the target sub-partition is determined based on the first intra prediction value and the second intra prediction value.

Exemplarily, weighted fusion is performed on the first intra prediction value and the second intra prediction value to determine the intra prediction value of the target sub-partition. The weighted fusion includes weighted fusion based on different weights and an averaging operation based on the same weight.

In some embodiments, the method further includes the following. A first weight of the first intra prediction value and a second weight of the second intra prediction value are determined based on a preset weight allocation strategy, where the second weight includes one or more weights corresponding to the one or more intra prediction values included in the second intra prediction value. That is, when the second intra prediction mode includes multiple (two or more) intra prediction modes, the second weight also includes multiple weights.

Exemplarily, the weight allocation strategy includes the following. When the second intra prediction mode includes a first preset mode, determine that the first weight is 1 and the second weight is 0. For example, the first preset mode may be the PLANAR mode or another default mode, and the another default mode may be an angular prediction mode.

Exemplarily, the weight allocation strategy includes the following. When the second intra prediction mode does not include the first preset mode, determine that the first weight is equal to the second weight. For example, each weight is a constant 1/n, where n is the number of modes used for weighted fusion.

Exemplarily, the weight allocation strategy can include determining a weight based on the prediction performance parameters of the intra prediction modes, where the prediction performance parameters indicate the performance of the first intra prediction mode and the second intra prediction mode when the first intra prediction mode and the second intra prediction mode are used for performing prediction on the reference sample, and can serve as a basis for weight allocation, to improve the prediction accuracy of the current block.

Specifically, the weight allocation strategy includes the following. A prediction performance parameter of the first intra prediction mode and a prediction performance parameter of the second intra prediction mode are added to obtain a total prediction performance parameter. The prediction performance parameter of the first intra prediction mode is divided by the total prediction performance parameter to obtain a first coefficient. The prediction performance parameter of the second intra prediction mode is divided by the total prediction performance parameter to obtain a second coefficient. Weight allocation is performed according to the first coefficient and the second coefficient to obtain the first weight and the second weight.

In some embodiments, weight allocation is performed according to the first coefficient and the second coefficient to obtain the first weight and the second weight as follows. A product of the first coefficient and a total weight is calculated to obtain the first weight. A product of the second coefficient and the total weight is calculated to obtain the second weight.

In some other embodiments, weight allocation is performed according to the first coefficient and the second coefficient to obtain the first weight and the second weight as follows. The total weight is split into a third weight and a fourth weight. A product of the first coefficient and the third weight is calculated and the fourth weight is added to the product, to obtain the first weight. A product of the second coefficient and the third weight is calculated to obtain the second weight.

In some embodiments, the method further includes the following. At least one of the first intra prediction mode, the second intra prediction mode, the first weight, or the second weight of the target sub-partition is stored. To fully utilize mode information of the current block for subsequent CBs, information, such as the second intra prediction mode, the weight, etc., can be stored in prediction information of each sub-partition, and the first intra prediction mode can be stored in prediction information of the current block as reference information for the subsequent CBs, to assist the prediction of the subsequent CBs.

At S1006, a reconstructed value of the target sub-partition is determined based on the intra prediction value of the target sub-partition.

Exemplarily, the method further includes the following. Residual information is obtained according to an original value of a sub-partition and an intra prediction value of the sub-partition. Transform and quantization are performed on the residual information to obtain a residual coefficient. Inverse quantization and inverse transform are performed on the residual coefficient, and then a reconstructed value of the sub-partition is obtained by combining the residual coefficient, subject to inverse quantization and inverse transform, with an intra prediction value of the sub-partition.

It can be noted that, if all sub-partitions in the current block have been reconstructed, the ISP mode for the current block will be exited, and an encoding process of another mode will continue or an encoding process of a subsequent picture block will continue.

At S1007, encoding decision is performed based on the reconstructed value of the target sub-partition to determine a prediction parameter of the current block, where the prediction parameter includes the first intra prediction mode.

In some embodiments, determine that all sub-partitions in the current block have been reconstructed. Encoding decision is performed according to a reconstructed value and an original value of the current block to determine whether to use the first intra prediction mode as the optimal intra prediction mode for the current block. The prediction parameter of the current block is determined according to a decision result. That is, the first intra prediction mode included in the prediction parameter is the optimal intra prediction mode for the current block. The optimal intra prediction mode may be determined and signalled into the bitstream by the encoding end for reading by the decoding end, or the optimal intra prediction mode may be derived by the encoding end according to the reconstructed neighbouring block of the current block. Similarly, the decoding end can derive the first intra prediction mode according to the reconstructed neighbouring block of the current block.

At S1008, the prediction parameter is encoded, and an obtained encoded bit is signalled into the bitstream.

In some embodiments, the prediction parameter further includes a first syntax element, where the first syntax element indicates whether the ISP mode is used for the current block. The prediction parameter can be encoded as follows. The first syntax element is encoded. Based on the determination, according to the first syntax element, that the ISP mode is used for the current block, the first intra prediction mode is encoded.

In some embodiments, the prediction parameter further includes a second syntax element, where the second syntax element indicates a split type for the current block. The prediction parameter is further encoded as follows. Based on the determination, according to the first syntax element, that the ISP mode is used for the current block, the second syntax element is encoded. The second syntax element indicates an optimal split type for the current block. For example, the encoding end determines the optimal split type for the current block from horizontal splitting and vertical splitting according to the decision result, and then determines a value of the second syntax element according to the optimal split type.

In some embodiments, the prediction parameter further includes a third syntax element, where the third syntax element indicates whether the second intra prediction mode is used for the current block for fusion prediction. The prediction parameter is further encoded as follows. Based on the determination, according to the first syntax element, that the ISP mode is used for the current block, the third syntax element is encoded.

It can be noted that, the target sub-partition encoded using the encoding method provided in embodiments of the disclosure can be one or more sub-partitions in the current block. Exemplarily, the target sub-partition may be any sub-partition in the current block, or may be certain specific sub-partitions in the current block. Exemplarily, the specific sub-partitions can be sub-partitions other than the first sub-partition. When the sub-partition is the first sub-partition, an intra prediction value of the first sub-partition is determined based on the first intra prediction value. When the sub-partition is another sub-partition, both the first intra prediction mode and the second intra prediction mode are used for weighted prediction.

With the technical solutions mentioned above, at the encoding end, when the ISP mode is used for the current block, content characteristics of the reconstructed region are fully utilized, the second intra prediction mode is adaptively selected, and fusion prediction is performed on sub-partitions by combining the second intra prediction mode with the first intra prediction mode, thereby improving the prediction accuracy of the ISP mode, reducing bitrate, and further enhancing encoding performance.

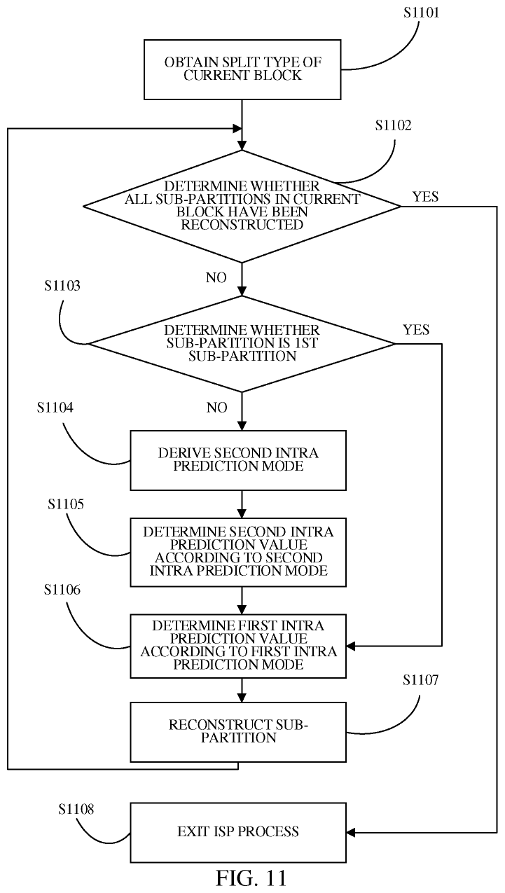

In yet another embodiment of the disclosure, reference may be made to FIG. 11, which is a schematic flowchart illustrating an encoding method and a decoding method provided in embodiments of the disclosure. As illustrated in FIG. 11, whether at an encoding end or a decoding end, the method may include the following.

At S1101, a split type for a current block is obtained.

A variable intra_subpartitions_mode_flag represents a first syntax element, indicating whether an ISP mode is used for the current block.

A variable intra_subpartitions_split_flag represents a second syntax element, indicating whether a split type for intra sub-partitions is horizontal or vertical.

A variable IntraSubPartitionsSplitType specifies a specific split type for a current luma CB, as illustrated in Table 1.

IntraSubPartitionsSplitType is derived as follows:
If intra_subpartitions_mode_flag is equal to 0, IntraSubPartitionsSplitType is set to 0.
Otherwise, IntraSubPartitionsSplitType is set to 1+intra_subpartitions_split_flag.

A variable NumIntraSubPartitions is used to specify the number of sub-partitions into which an intra luma CB is split. NumIntraSubPartitions is derived as follows:
If IntraSubPartitionsSplitType is equal to ISP_NO_SPLIT, NumIntraSubPartitions is set to 1.
Otherwise, if one of the following conditions is true, NumIntraSubPartitions is set to 2:
cbWidth is equal to 4, and cbHeight is equal to 8,
cbWidth is equal to 8, and cbHeight is equal to 4.
Otherwise, NumIntraSubPartitions is set equal to 4.

At S1102, whether all sub-partitions in the current block have been reconstructed is determined. If not all sub-partitions in the current block have been reconstructed, proceed to S1103. If all sub-partitions in the current block have been reconstructed, proceed to S1108.

The current block can be split into NumIntraSubPartitions sub-partitions. At S1103 to S1107, prediction and reconstruction on each sub-partition can be completed according to a preset decoding order. At S1102, whether operations at S1103 to S1107 have been completed for all NumIntraSubPartitions sub-partitions in the current CB is determined. If the operations at S1103 to S1107 have been completed for all NumIntraSubPartitions sub-partitions in the current CB, proceed to S1108. If the operations at S1103 to S1107 have not been completed for all NumIntraSubPartitions sub-partitions in the current CB, prediction and reconstruction in the operations at S1103 to S1107 are to be performed on a next sub-partition.

At S1103, whether a sub-partition is the first sub-partition is determined. If the sub-partition is not the first sub-partition, proceed to S1104. If the sub-partition is the first sub-partition, proceed to S1106.

As illustrated in FIG. 6, in horizontal splitting, the number of sub-partitions is 4, i.e., the variable intra_subpartitions_split_flag is 0, IntraSubPartitionsSplitType is 1, the variable NumIntraSubPartitions is 4, sequence numbers from 0 to 3 of the sub-partitions represent an encoding order of the sub-partitions, and a sub-partition numbered 0 is the first sub-partition. As illustrated in FIG. 7, in vertical splitting, the number of sub-partitions is 4, i.e., the variable intra_subpartitions_split_flag is 1, IntraSubPartitionsSplitType is 2, the variable NumIntraSubPartitions is 4, sequence numbers numbered from 0 to 3 of the sub-partitions represent the encoding order of the sub-partitions, and the sub-partition numbered 0 is the first sub-partition.

At S1104, a second intra prediction mode is derived according to a reference sample of the current sub-partition.

Exemplarily, the variable baseMode represents a first intra prediction mode, and a variable baseMode Weight represents the first weight. The variable fusionMode represents the second intra prediction mode. An array fusionModeWeight contains the second weight of fusionMode. The variable NumFusionMode represents the number of elements in fusionMode and fusionModeWeight.

### Mode 1, Gradient-Based Derivation Mode

A sub-partition numbered 1 in horizontal splitting is taken as an example.

Assume that coordinates of a top-left sample position of the current sub-partition relative to a top-left sample position of the picture are (x, y), the width of the sub-partition is Width, and the height of the sub-partition is Height.

Input: for the sub-partition, a luma sample in a reconstructed region in the current CB is p[x][y], where x=0 . . . Width−1, and y=−1 . . . −Height, i.e., a region of a sub-partition numbered 0. An origin point [0][0] is sample coordinates of the top-left corner in sub-partition 0. A sub-partition numbered 2 is taken as an example, and the input includes, but is not limited to, a reconstructed value of a sample in a sub-partition numbered 0, a reconstructed value of a sample in a sub-partition numbered 1, or both the reconstructed value of the sample in the sub-partition numbered 0 and the reconstructed value of the sample in the sub-partition numbered 1. The sub-partition numbered 0 is taken as an example, and the input includes, but is not limited to, a reconstructed value of a sample in a left neighbouring block and/or a reconstructed value of a sample in a top neighbouring block.

For a specific gradient-based derivation process, reference may be made to the foregoing descriptions, which will not be repeated herein.

Output: the second intra prediction mode fusionMode obtained through gradient-based derivation, with a mode index range of [0, 66].

### Mode 2, Template-Based Derivation Mode

A sub-partition numbered 1 in horizontal splitting is taken as an example.

The intra prediction modes are traversed to perform prediction on a region of the sub-partition numbered 0, and certain error values between a prediction value and a reconstructed value are calculated, including but not limited to an SAD, an SATD, an SSE, an MAD, an MAE, an MSE, etc. NumFusionMode intra prediction modes are selected according to the error values and then assigned to the array fusionMode.

At S1105, a second intra prediction value is determined according to the second intra prediction mode.

At S1106, a first intra prediction value is determined according to the first intra prediction mode.

Further, if the current sub-partition is not the first sub-partition, an intra prediction value of the current sub-partition is determined according to the first intra prediction value and the second intra prediction value. If the current sub-partition is the first sub-partition, the intra prediction value of the current sub-partition is determined according to the first intra prediction value. Exemplarily, a value of baseModeWeight and a value of each element in fusionMode Weight are determined according to a preset weight allocation strategy. Weighted fusion is performed on the first intra prediction value and the second intra prediction value according to baseMode Weight and fusionModeWeight, to obtain a prediction value of the sub-partition.

For another sub-partition other than the first sub-partition, intra weighted fusion prediction is performed. A specific process is as follows.

Assume that predBase is a prediction value of baseMode, predFusion is a prediction value of fusionMode, and predFusion[i] is a prediction value of fusionMode[i].

Log 2sumOfWeight is a base-2 logarithm of sumOfWeight.

Then, a prediction value pred subject to intra weighted fusion is calculated as follows:

for (int y = 0; y < height; y++)
{
for (int x = 0; x < width; x++)
{
pred[y][x] = predBase[y][x]*baseWeight;
for (int i = 0; i < NumFusionMode; i++)
{
pred[y][x] += predFusion [y][x]*fusion
Weight[i];
}
pred[y][x] = (pred[y][x] + (1
<< (Log2sumOfWeight - 1)) >>
Log2sumOfWeight;
}
}

The above calculation order and method are not limited to the forms described above.

Subsequent processing on the prediction value pred includes, but is not limited to, performing clip operation, etc.

The prediction value pred subject to intra weighted fusion may also be calculated as follows.

Assume that predBase is a prediction value of baseMode, predFusion is a prediction value of fusionMode, predFusion[i] is a prediction value of fusionMode[i], predPlanar is a prediction value of the Planar mode, and planarWeight is a weight of the Planar mode.

Log 2planarWeight is a base-2 logarithm of planarWeight.

for (int y = 0; y < height; y++)
{
for (int x = 0; x < width; x++)
{
pred[y][x] = predBase[y][x]*baseWeight;
for (int i = 0; i < NumFusionMode; i++)
{
pred[y][x] += predFusion [y][x]*fusion
Weight[i];
}
pred[y][x] += predPlanar
[y][x]*planarWeight;
pred[y][x] = (pred[y][x] + (1
<< (Log2sumOfWeight +
Log2planarWeight - 1))) >>
(Log2sumOfWeight +
Log2planarWeight)
}
}

At S1107, the sub-partition is reconstructed.

For the current sub-partition, reconstruction is performed. At the encoding end, transform and quantization are performed on residual information of the sub-partition to obtain a residual coefficient, inverse quantization and inverse transform are performed on the residual coefficient, and a reconstructed value of the sub-partition is obtained by combining the residual coefficient, subject to inverse quantization and inverse transform, with the intra prediction value of the sub-partition. At the decoding end, the bitstream is decoded to obtain the residual coefficient, inverse quantization and inverse transform are performed on the residual coefficient, and the reconstructed value of the sub-partition is obtained by combining the residual coefficient, subject to inverse quantization and inverse transform, with the intra prediction value of the sub-partition.

At S1108, an ISP process is exited.

In embodiments of the disclosure, the accuracy of ISP prediction can be improved while maintaining the bit-saving advantage of the ISP technology. By analyzing a reconstructed sub-partition, content characteristics of the reconstructed sub-partition can be fully utilized, and a second intra prediction mode for a subsequent sub-partition is adaptively selected. A weighted prediction method can enhance adaptability to blurred content and diverse textures in a picture, thereby improving the prediction accuracy of sub-partitions, and thus ensuring the universality of the ISP technology.

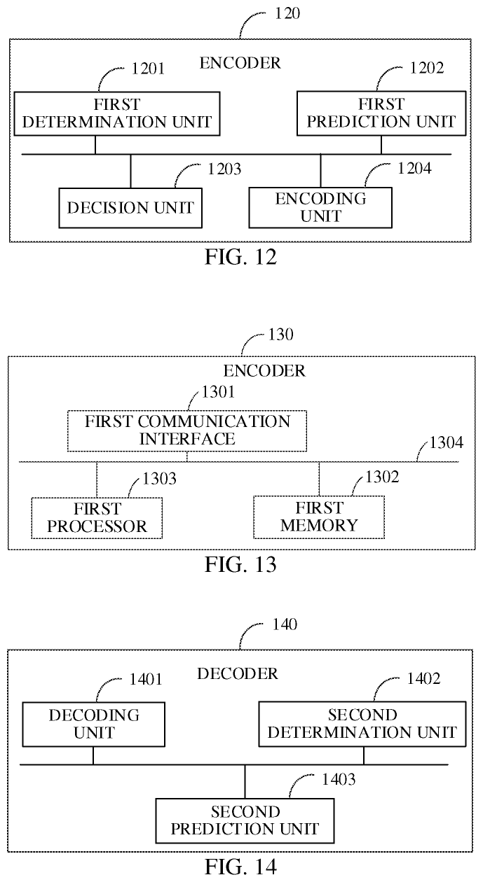

In still yet another embodiment of the disclosure, based on the same inventive concept as the foregoing embodiments, reference may be made to FIG. 12, which illustrates a schematic structural diagram of an encoder provided in embodiments of the disclosure. As illustrated in FIG. 12, the encoder 120 may include a first determination unit 1201, a first prediction unit 1202, a decision unit 1203, and an encoding unit 1204. The first determination unit 1201 is configured to determine a first intra prediction mode for a current block. The first prediction unit 1202 is configured to determine a first intra prediction value of a target sub-partition in the current block according to the first intra prediction mode. The first determination unit 1201 is further configured to determine a second intra prediction mode for the target sub-partition based on a reference sample of the target sub-partition, where the second intra prediction mode includes one or more intra prediction modes. The first prediction unit 1202 is further configured to determine a second intra prediction value of the target sub-partition according to the second intra prediction mode, where the second intra prediction value includes one or more intra prediction values determined according to the one or more intra prediction modes included in the second intra prediction mode. The first prediction unit 1202 is further configured to determine an intra prediction value of the target sub-partition based on the first intra prediction value and the second intra prediction value, and determine a reconstructed value of the target sub-partition based on the intra prediction value of the target sub-partition. The decision unit 1203 is configured to perform encoding decision based on the reconstructed value of the target sub-partition to determine a prediction parameter of the current block, where the prediction parameter includes the first intra prediction mode. The encoding unit 1204 is configured to encode the prediction parameter and signal an obtained encoded bit into a bitstream.

It can be understood that, each functional unit of the encoder also performs the encoding method in any one of the foregoing embodiments.

It can be understood that, in embodiments of the disclosure, the term “unit” may be a partial circuit, a partial processor, a partial program or software, etc. Certainly, the term “unit” may be a module or may be in a non-modular form. In addition, component parts in embodiments may be integrated into one processing unit, or each unit may exist alone physically, or two or more units may be integrated into one unit. The foregoing integrated unit may be implemented in a form of hardware, or may be implemented in a form of a software functional module.

If the integrated unit is implemented as a software functional module and sold or used as a standalone product, the integrated unit may be stored in a computer-readable storage medium. Based on such an understanding, the essential technical solution, or the portion that contributes to the prior art, or part of the technical solution of the disclosure may be embodied as software products. The computer software products can be stored in a storage medium and may include multiple instructions that, when executed, can cause a computer device, e.g., a personal computer, a server, a network device, etc., to execute some or all operations of the methods described in various embodiments of the disclosure. The above storage medium may include various kinds of media that can store program codes, such as a universal serial bus (USB) flash disk, a mobile hard drive, a read-only memory (ROM), a random access memory (RAM), a magnetic disk, or an optical disk.

Therefore, a computer-readable storage medium is provided in embodiments of the disclosure. The computer-readable storage medium is applicable to the encoder 120. The computer-readable storage medium stores a computer program which, when executed by a first processor, is operable to implement the method of any one of the foregoing embodiments.

A computer-readable storage medium is provided in embodiments of the disclosure. The computer-readable storage medium stores the bitstream generated according to the encoding method.

Based on the composition of the encoder 120 and the computer-readable storage medium, reference may be made to FIG. 13, which illustrates a schematic diagram of a specific hardware structure of an encoder 130 provided in embodiments of the disclosure. As illustrated in FIG. 13, the encoder 120 may include a first communication interface 1301, a first memory 1302, and a first processor 1303, where various components are coupled together via a first bus system 1304. It can be understood that, the first bus system 1304 is configured for connection and communication between these components. In addition to a data bus, the first bus system 1304 further includes a power bus, a control bus, and a status signal bus. However, for the convenience of illustration, various buses are marked as the first bus system 1304 in FIG. 13. The first communications interface 1301 is configured to receive and transmit signals in the process of transmitting and receiving information with other external network elements. The first memory 1302 is configured to store a computer program executable on the first processor 1303. The first processor 1303 is configured to execute the computer program to perform the following operations. A first intra prediction mode for a current block is determined. A first intra prediction value of a target sub-partition in the current block is determined according to the first intra prediction mode. A second intra prediction mode for the target sub-partition is determined based on a reference sample of the target sub-partition, where the second intra prediction mode includes one or more intra prediction modes. A second intra prediction value of the target sub-partition is determined according to the second intra prediction mode, where the second intra prediction value includes one or more intra prediction values determined according to the one or more intra prediction modes included in the second intra prediction mode. An intra prediction value of the target sub-partition is determined based on the first intra prediction value and the second intra prediction value. A reconstructed value of the target sub-partition is determined based on the intra prediction value of the target sub-partition. Encoding decision is performed based on the reconstructed value of the target sub-partition to determine a prediction parameter of the current block, where the prediction parameter includes the first intra prediction mode. The prediction parameter is encoded, and an obtained encoded bit is signalled into a bitstream.

It can be understood that, the first memory 1302 in embodiments of the disclosure may be a volatile memory or a non-volatile memory, or may include both the volatile memory and the non-volatile memory. The non-volatile memory may be an ROM, a programmable ROM (PROM), an erasable PROM (EPROM), an electrically EPROM (EEPROM), or flash memory. The volatile memory may be an RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). The first memory 1302 of the systems and methods described in the disclosure is intended to include, but is not limited to, these and any other suitable types of memory.

The first processor 1303 may be an integrated circuit chip with signal processing capabilities. During embodiment, each step of the foregoing method embodiments may be completed by an integrated logic circuit of hardware in the first processor 1303 or an instruction in the form of software. The first processor 1303 may be a general-purpose processor, a digital signal processor (DSP), an application-specific integrated circuit (ASIC), a field programmable gate array (FPGA), or other programmable logic devices, discrete gates or transistor logic devices, or discrete hardware components. The methods, steps, and logic blocks disclosed in embodiments of the disclosure can be implemented or executed. The general-purpose processor may be a microprocessor, or the processor may be any conventional processor or the like. The steps of the method disclosed in embodiments of the disclosure may be directly implemented by a hardware decoding processor, or may be performed by hardware and software modules in the decoding processor. The software module can be located in a storage medium such as an RAM, a flash memory, an ROM, a PROM, or an electrically erasable programmable memory, registers, etc. The storage medium is located in the first memory 1302. The first processor 1303 reads information from the first memory 1302, and completes the steps of the method described above with the hardware thereof.

It can be understood that, these embodiments described in the disclosure may be implemented by hardware, software, firmware, middleware, microcode, or a combination thereof. For hardware implementation, the processing unit may be implemented in one or more ASICs, DSPs, digital signal processing devices (DSP Devices, DSPDs), programmable logic devices (PLDs), FPGAs, general-purpose processors, controllers, microcontrollers, microprocessors, and other electronic units configured to perform the functions described in the disclosure, or a combination thereof. For software implementation, the techniques described in the disclosure can be implemented by modules (such as processes and functions) that perform the functions described in the disclosure. Software code may be stored in a memory and executed by a processor. The memory may be implemented in the processor or outside the processor.

Optionally, in another embodiment, the first processor 1303 is further configured to perform the method of any one of the foregoing embodiments when executing the computer program.

The encoder is provided in the disclosure. In the encoder, a virtual reference picture is adjusted using a target adjustment factor, to improve the quality of the virtual reference picture, thereby improving the prediction accuracy of a current frame, and thus enhancing encoding performance.

In still yet another embodiment of the disclosure, based on the same inventive concept as the foregoing embodiments, reference may be made to FIG. 14, which illustrates a schematic structural diagram of a decoder 140 provided in embodiments of the disclosure. As illustrated in FIG. 14, the decoder 140 may include a decoding unit 1401, a second determination unit 1402, and a second prediction unit 1403. The decoding unit 1401 is configured to decode a bitstream to determine a prediction parameter of a current block, where the prediction parameter includes a first intra prediction mode. The second prediction unit 1403 is configured to determine a first intra prediction value of a target sub-partition in the current block according to the first intra prediction mode. The second determination unit 1402 is configured to determine a second intra prediction mode for the target sub-partition based on a reference sample of the target sub-partition, where the second intra prediction mode includes one or more intra prediction modes. The second prediction unit 1403 is further configured to determine a second intra prediction value of the target sub-partition according to the second intra prediction mode, where the second intra prediction value includes one or more intra prediction values determined according to the one or more intra prediction modes included in the second intra prediction mode. The second prediction unit 1403 is further configured to determine an intra prediction value of the target sub-partition based on the first intra prediction value and the second intra prediction value, and determine a reconstructed value of the target sub-partition based on the intra prediction value of the target sub-partition.

It can be understood that, each functional unit of the decoder also performs the decoding method in any one of the foregoing embodiments.

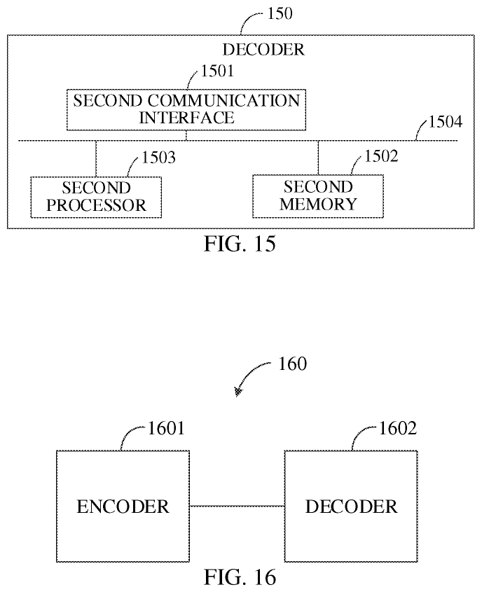

Based on the composition of a decoder 150 and the computer-readable storage medium, reference may be made to FIG. 15, which illustrates a schematic diagram of a specific hardware structure of a decoder 150 provided in embodiments of the disclosure. As illustrated in FIG. 15, the decoder 150 may include a second communication interface 1501, a second memory 1502, and a second processor 1503, where various components are coupled together via a second bus system 1504. It can be understood that, the second bus system 1504 is configured for connection and communication between these components. In addition to a data bus, the second bus system 1504 further includes a power bus, a control bus, and a status signal bus. However, for the convenience of illustration, various buses are marked as the second bus system 1504 in FIG. 15. The second communications interface 1501 is configured to receive and transmit signals in the process of transmitting and receiving information with other external network elements. The second memory 1502 is configured to store a computer program executable on the second processor 1503. The second processor 1503 is configured to execute the computer program to perform the following operations. A bitstream is decoded to determine a prediction parameter of a current block, where the prediction parameter includes a first intra prediction mode. A first intra prediction value of a target sub-partition in the current block is determined according to the first intra prediction mode. A second intra prediction mode for the target sub-partition is determined based on a reference sample of the target sub-partition, where the second intra prediction mode includes one or more intra prediction modes. A second intra prediction value of the target sub-partition is determined according to the second intra prediction mode, where the second intra prediction value includes one or more intra prediction values determined according to the one or more intra prediction modes included in the second intra prediction mode. An intra prediction value of the target sub-partition is determined based on the first intra prediction value and the second intra prediction value. A reconstructed value of the target sub-partition is determined based on the intra prediction value of the target sub-partition.

Optionally, in another embodiment, the second processor 1503 is further configured to execute the computer program to perform the method of any one of the foregoing embodiments.

It can be understood that, the second memory 1502 has similar hardware functions to the first memory 1302, and the second processor 1503 has similar hardware functions to the first processor 1303, which are not repeated herein.

The decoder is provided in the disclosure. In the decoder, a virtual reference picture is adjusted using a target adjustment factor, to improve the quality of the virtual reference picture, thereby improving the prediction accuracy of a current frame, and thus enhancing decoding performance.

In still yet another embodiment of the disclosure, reference may be made to FIG. 16, which illustrates a schematic structural diagram of a coding system provided in embodiments of the disclosure. As illustrated in FIG. 16, the coding system 160 may include an encoder 1601 and a decoder 1602.

In embodiments of the disclosure, the encoder 1601 can be the encoder in any one of the foregoing embodiments, and the decoder 1602 can be the decoder in any one of the foregoing embodiments.

It can be noted that, in the disclosure, the terms “include”, “comprise”, and “have” as well as variations thereof are intended to cover a non-exclusive inclusion, such that a process, a method, an object, or an apparatus that includes a series of elements not only includes those elements, but also includes other elements that are not explicitly listed, or includes inherent elements of the process, method, object or apparatus. In the absence of further restrictions, the element limited by a sentence “including a” does not exclude the existence of other identical elements in the process, method, item, or device including the element.

The sequence numbers of embodiments of the disclosure are only for description, and do not represent superiority or inferiority of the embodiments.

The methods disclosed in the several method embodiments provided in the disclosure may be randomly combined with each other in the case of no conflicts, to obtain new method embodiments.

The features disclosed in the several product embodiments provided in the disclosure may be randomly combined with each other in the case of no conflicts, to obtain new product embodiments.

The features disclosed in the several method or device embodiments provided in the disclosure may be randomly combined with each other in the case of no conflicts, to obtain new method embodiments or device embodiments.

The above are merely embodiments of the disclosure, but are not intended to limit the protection scope of the disclosure. Any variation or replacement easily thought of by those skilled in the art within the technical scope disclosed in the disclosure shall belong to the protection scope of the disclosure. Therefore, the protection scope of the disclosure shall be subject to the protection scope of the claims.

### INDUSTRIAL APPLICABILITY

An encoding method, a decoding method, an encoder, a decoder, and a storage medium are provided in embodiments of the disclosure. In the disclosure, whether at an encoding end or a decoding end, a first intra prediction value of a target sub-partition in a current block is determined according to a first intra prediction mode, a second intra prediction mode for the target sub-partition is determined based on a reference sample of the target sub-partition, a second intra prediction value of the target sub-partition is determined according to the second intra prediction mode, and an intra prediction value of the target sub-partition is determined based on the first intra prediction value and the second intra prediction value. As such, when an intra sub-partitions (ISP) mode is used for the current block, content characteristics of a reconstructed region are fully utilized, the second intra prediction mode is adaptively selected, and fusion prediction is performed on sub-partitions by combining the second intra prediction mode with the first intra prediction mode, thereby improving prediction accuracy of the ISP mode, and thus further enhancing coding performance.

What is claimed is:

1. A decoding method, applied to a decoder and comprising:
decoding a bitstream to determine a prediction parameter of a current block, wherein the prediction parameter comprises a first intra prediction mode;
determining a first intra prediction value of a target sub-partition in the current block according to the first intra prediction mode;
determining a second intra prediction mode for the target sub-partition based on a reference sample of the target sub-partition, wherein the second intra prediction mode comprises one or more intra prediction modes;
determining a second intra prediction value of the target sub-partition according to the second intra prediction mode, wherein the second intra prediction value comprises one or more intra prediction values determined according to the one or more intra prediction modes comprised in the second intra prediction mode;
determining an intra prediction value of the target sub-partition based on the first intra prediction value and the second intra prediction value; and
determining a reconstructed value of the target sub-partition based on the intra prediction value of the target sub-partition.

2. The method of claim 1, wherein
the prediction parameter further comprises a first syntax element, wherein the first syntax element indicates whether an intra sub-partitions (ISP) mode is used for the current block; and
decoding the bitstream to determine the prediction parameter of the current block comprises:
decoding the bitstream to determine the first syntax element of the current block; and
decoding the bitstream to determine the first intra prediction mode based on a determination, according to the first syntax element, that the ISP mode is used for the current block.

3. The method of claim 2, wherein
the prediction parameter further comprises a second syntax element, wherein the second syntax element indicates a split type for the current block; and
decoding the bitstream to determine the prediction parameter of the current block further comprises:
decoding the bitstream to determine the second syntax element based on the determination, according to the first syntax element, that the ISP mode is used for the current block.

4. The method of claim 2, wherein
the prediction parameter further comprises a third syntax element, wherein the third syntax element indicates whether the second intra prediction mode is used for the current block for fusion prediction; and
decoding the bitstream to determine the prediction parameter of the current block further comprises:
decoding the bitstream to determine the third syntax element based on the determination, according to the first syntax element, that the ISP mode is used for the current block.

5. The method of claim 1, wherein the reference sample comprises a neighbouring reconstructed sample of the target sub-partition.

6. The method of claim 5, further comprising:
determining the neighbouring reconstructed sample of the target sub-partition from a reconstructed neighbouring block of the target sub-partition.

7. The method of claim 6, wherein a reconstructed neighbouring block of a first sub-partition in the current block comprises at least one of: a left neighbouring block of the first sub-partition, or a top neighbouring block of the first sub-partition, wherein the first sub-partition is a sub-partition to be decoded first according to a decoding order of sub-partitions in the current block.

8. The method of claim 6, wherein a reconstructed neighbouring block of another sub-partition in the current block comprises one or more reconstructed sub-partitions in the current block, wherein the another sub-partition is one or more sub-partitions other than a first sub-partition determined according to a decoding order of sub-partitions in the current block.

9. The method of claim 8, wherein the reconstructed neighbouring block of the another sub-partition further comprises another reconstructed neighbouring block of the another sub-partition.

10. The method of claim 1, wherein determining the second intra prediction mode for the target sub-partition based on the reference sample of the target sub-partition comprises:
determining prediction performance parameters of a plurality of candidate intra prediction modes by using a first derivation mode based on the reference sample; and
determining the one or more intra prediction modes comprised in the second intra prediction mode according to the prediction performance parameters.

11. The method of claim 10, wherein
the first derivation mode comprises a gradient-based derivation mode; and
a mode derivation method of the gradient-based derivation mode comprises:
performing gradient analysis on the reference sample to determine gradient magnitudes of a plurality of candidate intra prediction modes in a first mode set;
determining at least one gradient magnitude according to a descending order of the gradient magnitudes when the gradient magnitudes of the plurality of candidate intra prediction modes comprise a non-zero value;
determining at least one mode index according to a gradient angle corresponding to the at least one gradient magnitude; and
determining the one or more intra prediction modes comprised in the second intra prediction mode according to the at least one mode index.

12. The method of claim 1, wherein the second intra prediction mode further comprises a third preset mode.

13. The method of claim 1, wherein determining the intra prediction value of the target sub-partition based on the first intra prediction value and the second intra prediction value comprises:
performing weighted fusion on the first intra prediction value and the second intra prediction value to determine the intra prediction value of the target sub-partition.

14. The method of claim 13, further comprising:
determining a first weight of the first intra prediction value and a second weight of the second intra prediction value based on a preset weight allocation strategy, wherein the second weight comprises one or more weights corresponding to the one or more intra prediction values comprised in the second intra prediction value.

15. An encoding method, applied to an encoder and comprising:
determining a first intra prediction mode for a current block;
determining a first intra prediction value of a target sub-partition in the current block according to the first intra prediction mode;
determining a second intra prediction mode for the target sub-partition based on a reference sample of the target sub-partition, wherein the second intra prediction mode comprises one or more intra prediction modes;
determining a second intra prediction value of the target sub-partition according to the second intra prediction mode, wherein the second intra prediction value comprises one or more intra prediction values determined according to the one or more intra prediction modes comprised in the second intra prediction mode;
determining an intra prediction value of the target sub-partition based on the first intra prediction value and the second intra prediction value; and
determining a reconstructed value of the target sub-partition based on the intra prediction value of the target sub-partition.

16. The method of claim 15, further comprising:
performing encoding decision based on the reconstructed value of the target sub-partition to determine a prediction parameter of the current block, wherein the prediction parameter comprises the first intra prediction mode; and
encoding the prediction parameter, and signalling an obtained encoded bit into a bitstream.

17. The method of claim 16, wherein
the prediction parameter further comprises a first syntax element, wherein the first syntax element indicates whether an intra sub-partitions (ISP) mode is used for the current block; and
encoding the prediction parameter comprises:
encoding the first syntax element; and
encoding the first intra prediction mode based on a determination, according to the first syntax element, that the ISP mode is used for the current block.

18. The method of claim 17, wherein
the prediction parameter further comprises a second syntax element, wherein the second syntax element indicates a split type for the current block; and
encoding the prediction parameter further comprises:
encoding the second syntax element based on the determination, according to the first syntax element, that the ISP mode is used for the current block.

19. The method of claim 17, wherein
the prediction parameter further comprises a third syntax element, wherein the third syntax element indicates whether the second intra prediction mode is used for the current block for fusion prediction; and
encoding the prediction parameter further comprises:
encoding the third syntax element based on the determination, according to the first syntax element, that the ISP mode is used for the current block.

20. A non-transitory computer-readable storage medium storing a bitstream and a computer program which, when executed by a processor, causes the processor to implement an encoding method to generate the bitstream, the encoding method comprising:
determining a first intra prediction mode for a current block;
determining a first intra prediction value of a target sub-partition in the current block according to the first intra prediction mode;
determining a second intra prediction mode for the target sub-partition based on a reference sample of the target sub-partition, wherein the second intra prediction mode comprises one or more intra prediction modes;
determining a second intra prediction value of the target sub-partition according to the second intra prediction mode, wherein the second intra prediction value comprises one or more intra prediction values determined according to the one or more intra prediction modes comprised in the second intra prediction mode;
determining an intra prediction value of the target sub-partition based on the first intra prediction value and the second intra prediction value; and
determining a reconstructed value of the target sub-partition based on the intra prediction value of the target sub-partition.
